(19) United States
(12) Patent Application Publication
(10) Pub. No.: US 2022/0327460 A1
(43) Pub. Date: Oct. 13, 2022

(54) SYSTEMS AND METHODS FOR SCALED ENGINEERING

(71) Applicant: AT&T Intellectual Property I, L.P., Atlanta, GA (US)

(72) Inventor: Keith E Gibson, Downintown, PA (US)

(21) Appl. No.: 17/229,178

(22) Filed: Apr. 13, 2021

(51) Int. Cl. G06Q 10/06; G06K 9/62

(52) U.S. Cl. CPC G06Q 10/063112; G06Q 10/06398; G06Q 10/0633; G06K 9/6215

(57) ABSTRACT

A system can comprise a processor and a memory that stores executable instructions that, when executed by the processor, facilitate performance of operations, comprising based on survey data representative of a group of completed surveys, determining skill data representative of skills of a group of profiles associated with the group of completed surveys, based on the skill data, determining pod data representative of capabilities to solve a defined problem, based on the pod data, determining profiles of the group of profiles that comprise respective skills, of the skills, that correspond to the capabilities. and assigning the profiles to a pod of agents, wherein the pod of agents is associated with the defined problem.

### TECHNICAL FIELD

The disclosed subject matter relates to engineering profile creation and matching, and generation of engineering pods for use in scaled engineering.

### BACKGROUND

Engineering team grouping is traditionally organized by industry. Teams are broken down into organizations that are account-focused and have account context as an overriding feature. This account-focus leads to monolithic skillset utilization. However, with increasing technical diversity and industry diversification with information technology environments becoming increasingly vendor-diverse, engineering team efficiency is reduced and cannot adapt quickly enough to industry changes. Additionally, existing team environments do not facilitate optimal skill development.

### BRIEF DESCRIPTION OF DRAWINGS

FIG. 1 is a block diagram of an exemplary pod in accordance with one or more embodiments described herein.

FIG. 2 is a block diagram of an exemplary pod in accordance with one or more embodiments described herein.

FIG. 3 is a block diagram of exemplary pods in accordance with one or more embodiments described herein.

FIG. 4 is a block diagram of exemplary account profile information in accordance with one or more embodiments described herein.

FIG. 5 is an exemplary responsibility assignment (RACI) matrix in accordance with one or more embodiments described herein.

FIG. 6 is a block diagram of an exemplary process in accordance with one or more embodiments described herein.

FIG. 7 is a block diagram of an exemplary pod in accordance with one or more embodiments described herein.

FIG. 8 is an exemplary RACI matrix in accordance with one or more embodiments described herein.

FIG. 9 is a flowchart of exemplary process in accordance with one or more embodiments described herein.

FIGS. 10A and 10B are exemplary rating diagrams in accordance with one or more embodiments described herein.

FIG. 11 is a block diagram of exemplary resource profile information in accordance with one or more embodiments described herein.

FIG. 12 is an exemplary spectrum map in accordance with one or more embodiments described herein.

FIGS. 13A, 13B, and 13C are exemplary skill spectrum maps in accordance with one or more embodiments described herein.

FIG. 14 is an exemplary heatmap in accordance with one or more embodiments described herein.

FIG. 15 is a block diagram of an exemplary system in accordance with one or more embodiments described herein.

FIG. 16 is a flowchart of exemplary process in accordance with one or more embodiments described herein.

FIG. 17 is a block flow diagram in accordance with one or more embodiments described herein.

FIG. 18 is a block flow diagram in accordance with one or more embodiments described herein.

FIG. 19 is a block flow diagram in accordance with one or more embodiments described herein.

FIG. 20 is an example, non-limiting computing environment in which one or more embodiments described herein can be implemented.

FIG. 21 is an example, non-limiting networking environment in which one or more embodiments described herein can be implemented.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

According to an embodiment, a system can comprise a processor, and a memory that stores executable instructions that, when executed by the processor, facilitate performance of operations, comprising based on survey data representative of a group of completed surveys, determining skill data representative of skills of a group of profiles associated with the group of completed surveys, based on the skill data, determining pod data representative of capabilities to solve a defined problem, based on the pod data, determining profiles of the group of profiles that comprise respective skills, of the skills, that correspond to the capabilities, and assigning the profiles to a pod of agents, wherein the pod of agents is associated with the defined problem.

In one or more embodiments, determining the skill data can comprise determining the skills using respective ratings assigned to the group of profiles.

In various embodiments, operations of systems herein can comprise receiving a ticket indicative of a support task, determining information associated with the support task, based on the information associated with the support task, determining whether the support task corresponds to the defined problem, and in response to determining that the support task corresponds to the defined problem, assigning the pod of agents to the support task.

In one or more embodiments, the information associated with the support task comprises an engineering risk grade can comprise a risk value associated with a risk of implementing a change associated with the support task.

It is noted that determining the pod of agents can be based on a model generated using machine learning based on past assignments of pods of agents to support tasks.

In various embodiments, operations further comprise determining a quality level associated with the assigning of the pod of agents to the support task in response to the support task being determined to be completed.

According to an embodiment, quality level herein can be indicative of an amount of time to solve the support task.

It is noted that assigning the profiles to the pod of agents can be based on a model generated using machine learning based on past assignments of profiles to pods of agents.

According to an example, a pod of agents can consist of five agents.

In one or more embodiments, the profiles herein can comprise at least one subject matter expert profile, and the subject matter expert profile can be determined, according to a defined criterion, to comprise a skill level above a subject matter expert skill level threshold for the defined problem.

In another embodiment, a non-transitory machine-readable medium can comprise executable instructions that, when executed by a processor, facilitate performance of operations, comprising receiving, from equipment, a support request corresponding to an information technology problem, determining, based on the support request and using machine learning, support information associated with the support request, wherein the support information comprises an identifier associated with the information technology problem, based on the support information, determining an engineering pod from a group of engineering pods, wherein the engineering pod is determined to comprise a skill associated with the identifier, and assigning the engineering pod comprising the skill to perform a task for the support request.

In one or more embodiments, assigning the engineering pod comprising the skill to perform a task for the support request can comprise assigning a first engineering pod comprising the skill to perform a first task for the support request, and the operations can further comprise in response to a defined amount of time elapsing between a first time comprising assigning the first engineering pod to perform the first task and a second time occurring after the first time, assigning a second engineering pod to perform a second task for the support request.

It is noted that the second task can be different than the first task, wherein the engineering pod can be a primary resolution pod, and wherein the second engineering pod can be a temporary resolution pod. In various embodiments, the temporary resolution pod can be generated, using the machine learning, based on the identifier and the primary resolution pod, and wherein the temporary resolution pod can comprise a subject matter expert profile determined to be associated with the identifier.

In one or more embodiments, the operations can further comprise determining a first success metric associated with the primary resolution pod and a second success metric associated with the temporary resolution pod, and updating a model of pods comprising the primary resolution pod and the temporary resolution pod with the first success metric and the second success metric, wherein the model of pods has been generated based on the machine learning as applied to past performance information representative of past performances of engineering pods.

In one or more embodiments, a first pod member of the engineering pod can comprise the skill and a second member of the engineering pod does not comprise the skill, and the operations can further comprise: associating the skill with the second member in response to satisfaction of a defined upskill criterion by the engineering pod.

In various embodiments, the defined upskill criterion can comprise a total threshold time performed by the engineering pod on information technology problems determined to be similar to the information technology problem according to a similarity criterion.

According to an embodiment, operations can further comprise determining a group of profiles other than profiles of the engineering pod, wherein each profile of the group of profiles comprises the skill and is a respective member of a pod other than the engineering pod, and assigning the group of profiles to the support request.

In yet another embodiment, a method can comprise determining, by a system comprising a processor, problem information associated with a problem and solution information representative of a solution associated with the problem, wherein the solution was performed by a solution pod, updating, by the system, a model comprising past performance information representative of past performance of other solutions to other problems performed by solution pods other than the solution pod, wherein the model is updated with the problem information and the solution information, and wherein the model has been generated using machine learning applied to the past performance information, in response to the solution being determined to rank higher than the other solutions according to a defined ranking criterion, designating, by the system, the solution as being associated with the problem, and generating, by the system, recommendation data to be used for a recommendation for a problem that is to be encountered later and that is determined to be similar to the problem according to a similarity criterion, wherein the recommendation data comprises the solution information.

It is noted that the solution pod can comprise at least two engineering profiles and a subject matter expert profile.

It should be appreciated that additional manifestations, configurations, implementations, protocols, etc. can be utilized in connection with the following components described herein or different/additional components as would be appreciated by one skilled in the art.

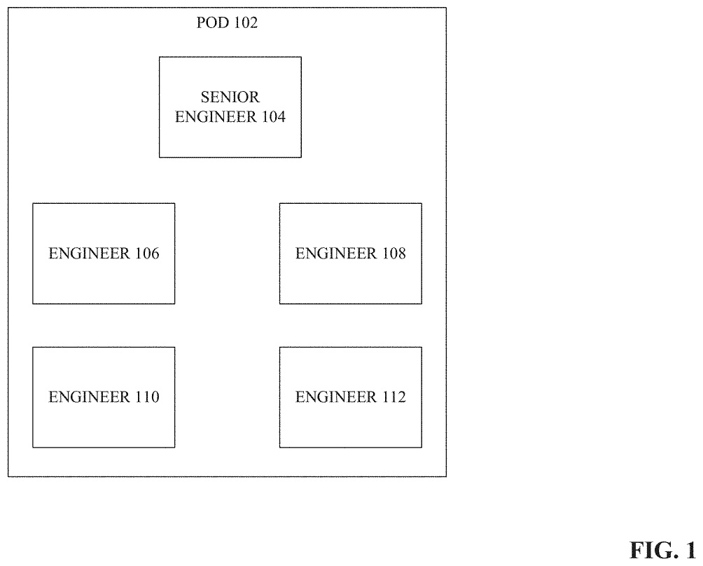

Turning now to FIG. 1, there is illustrated an exemplary pod 102 in accordance with one or more embodiments described herein. According to an example, a pod 102 can comprise five engineering resources or engineer profiles. For instance, pod 102 can comprise a senior engineer resource 104, engineer resource 106, engineer resource 108, engineer resource 110, and/or engineer resource 112. It is noted that while pod 102 comprises four engineer resources 106, 108, 110, and 112 and one senior engineer resource 104, other combinations of engineer resources, senior engineer resources, or other resources/profiles can be utilized in pod 102, such as subject matter expert resources, on-call technician resources, management resources, first touch resources, or other resources/profiles. Is it noted that pods herein can be scalable and can change sizes and/or memberships (e.g., depending on engineering specifications). Pods herein can distribute engineering tasks, reduce cycle time, eliminate errors in change execution, and/or reduce Mean Time to Repair (MTTR). Scaled engineering as described herein can represent a departure from the tiered hierarchical model of technical support traditionally used in industry. Scaled engineering herein can utilize modular adaptive modeling and insight modeling. Modular-adaptive modeling can comprise a process of building into a pod (e.g., pod 102) known implicated resources, but also allow for the addition of skillsets into the structure, dynamically, as time passes or resource implications/challenges change. Insight modeling can comprise the process of using captured data to drive workflows, assignments, associations, etc. dynamically and in real-time.

According to an embodiment, pod 102 can comprise an engineering pool to provide comprehensive operational support for a service line. It is noted that each pod can comprise a pod profile (e.g., profile information) that includes supported service lines. It is noted that each pod 102 can support many devices within a service line (e.g., 2000-4000 devices). It is noted that each pod 102 can comprise a skill spectrum (later discussed in greater detail) and is not restricted to a single skill support.

It is noted that by assigning engineering resources to pod 102, mentoring and coaching can be facilitated so that skillsets of engineering resources can be refined. It is also noted that the pod 102 can be scalable, such that resources or the size of the pod 102 can be modified (e.g., by system 1502 as later discussed in greater detail).

According to an embodiment, the senior engineer resource 104 can be responsible for quality control (e.g., for information such as change information generated by the pod 102). It is noted that systems herein (e.g., system 1502) can make such assignments and designate such responsibilities.

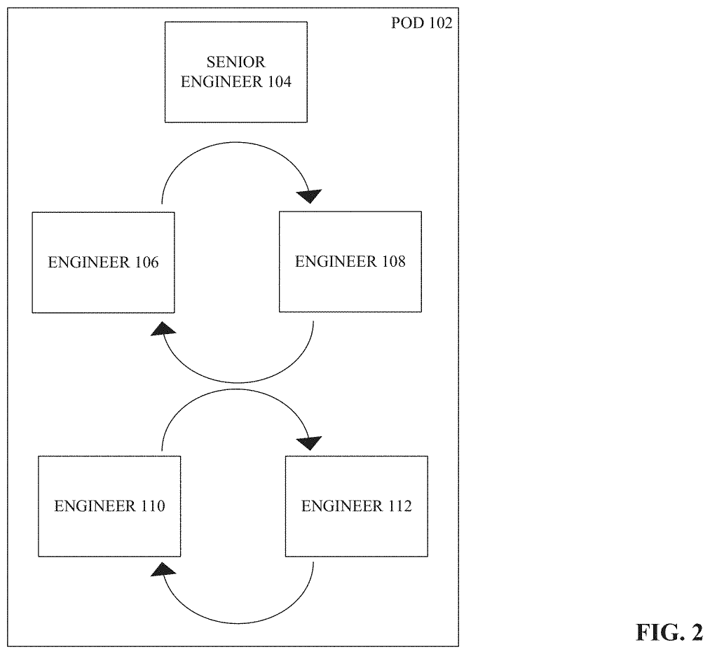

FIG. 2 illustrates exemplary peer review within a pod 102. According to an example, peer review can occur in pairs. For instance, engineer resource 106 and engineer resource 108 can be paired in order to facilitate each other's peer review. Likewise, engineer resource 110 and engineer resource 112 can be paired in order to facilitate each other's peer review. This peer review can comprise a gateway process and changes herein can receive peer-review signoff before progressing to a scaled engineering change review board or to change implementation. In this regard, a system herein (e.g., a system 1502) can assign changes from engineer resource 106 to be review by engineer resource 108 before progressing to a scaled engineering change review board or to change implementation. Likewise, systems herein can assign changes from engineer resource 112 to be review by engineer resource 110 before progressing to a scaled engineering change review board or to change implementation.

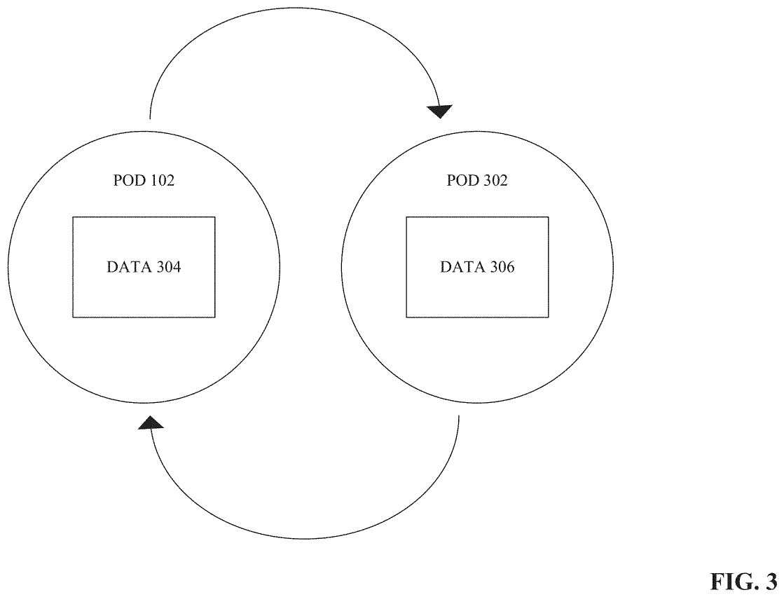

FIG. 3 illustrates exemplary peer-pod review in accordance with one or more embodiments described herein. Complex or high-risk changes that, for instance, are owned by a pod's (e.g., pod 102) senior engineer resource (e.g., senior engineer resource 104) can be peer reviewed through peer-pod review. In this regard, changes can be required to receive agreement between senior engineer resource 104 and a senior engineer resource of pod 302. For example, data 304 (e.g., engineering changes) can be reviewed by pod 302, and data 306 (e.g., engineering changes) can be reviewed by pod 102. It is noted that the system 1502 can determine a match between pod 102 and pod 302 for the facilitation of peer-pod review. It is also noted that each pod (e.g., pod 102) can comprise a designated peer-pod (e.g., pod 302). This fixed link between pods 102 and 302 can be based on common skillsets or skill spectrums (later discussed in greater detail) between pods 102 and 302. Other peer-pod links can comprise dynamic links, which can comprise temporary links based on a workflow. In this regard, links between pods can be generated (e.g., by system 1502) based on workflows, problems, changes, engineering risks, or other factors.

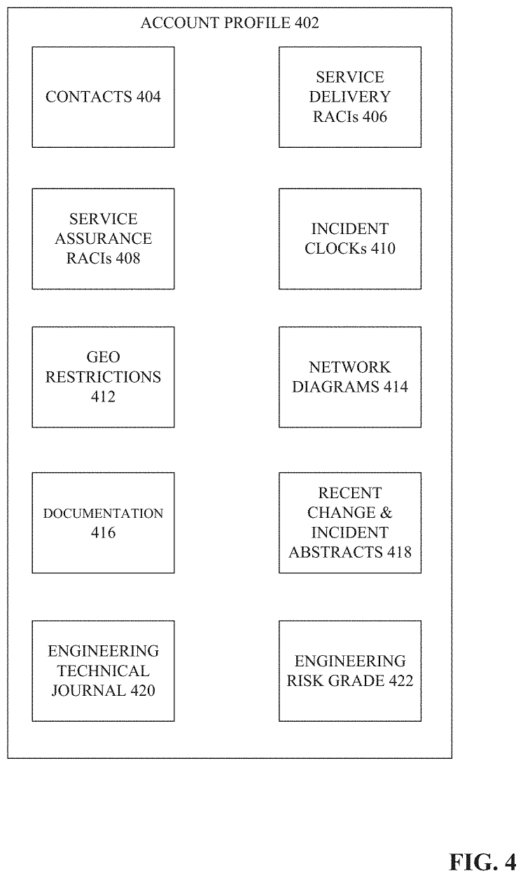

FIG. 4 illustrates an account profile 402 in accordance with one or more embodiments described herein. Account profile 402 can be associated with a customer or account registered with systems herein (e.g., system, 1502). According to an embodiment, account profile 402 can comprise contacts 404, service delivery RACIs 406, service assurance RACI matrices 408, incident clocks 410, geo-restrictions 412, network diagrams 414, documentation 416, recent change & incident abstracts 418, engineering technical journal 420, and/or engineering risk grade (ERG) 422.

Contacts can comprise contact resources associated with a customer or corporation associated with the account profile 402. RACI matrices 408 can comprise responsible resources for various responsibilities associated with the account profile 402. Incident clocks can comprise amounts of time allotted for designated tasks or responsibilities in association with a support request or ticket. Geo-restrictions 412 can comprise geographic restrictions associated with the account profile 402. For instance, the account profile 402 may only permit (e.g., for legal reasons) that a resource from Nation Z may permitted to be associated with the account profile 402. Network diagrams 414 can comprise network diagrams associated with the account profile 402 which, for instance, can be provided by a system 1502 along with a support request or ticket. Documentation 416 can comprise various relevant information associated with the account profile 402. recent change & incident abstracts 418 can comprise one or more engineering changes or support resolutions associated with the customer profile 402 (e.g., as facilitated by the system 1502). The engineering technical journal 420 can comprise various historical information associated with the account profile 402.

Account profiles herein (e.g., account profile 402) can comprise a respective engineering risk grade (ERG) 422, for instance, from grading levels 1-5. It is noted that an ERG can represent a risk value associated with a risk of implementing a change associated with a support task. Each grading level can trigger various actions by systems herein (e.g., system 1502) associated with the implementation of changes in dynamic environments. For example, the higher the ERG, the greater scrutiny and progressive process implementation to ensure success throughout an engineering change lifecycle. ERGs herein can be assigned by the system 1502 (e.g., using the machine learning (ML) component 1508) based on information stored in the data storage 1534. According to an example, an ERG 422 can be determined according to account information, resources associated with the account, problem information, links to associated documentation, associated change success rates (e.g., of the same account, similar account, same change, similar change, same problem, similar problem, etc.), and/or other relevant information. Determining an ERG 422 can comprise process mapping for a future step or action (e.g., an engineering change).

According to an example, ERG 1 can be optimal, and systems herein (e.g., system 1502) can require peer review for ERG 1. ERG can be stable, and systems herein (e.g., system 1502) can accordingly assign associated changes for senior engineer resource 104 signoff. ERG 3 can be unstable, and systems herein can accordingly assign associated changes for senior engineer resource 104 signoff in addition to presentation to an engineering review board. ERG 4 can be critical, and systems herein can accordingly assign associated changes for senior engineer resource 104 signoff, peer-pod review, two-week lead time, and presentation to an engineering review board. ERG 5 can be crisis, and systems herein can accordingly assign associated changes for senior engineer resource 104 signoff, peer-pod review, three-week lead time, and presentation to an engineering review board.

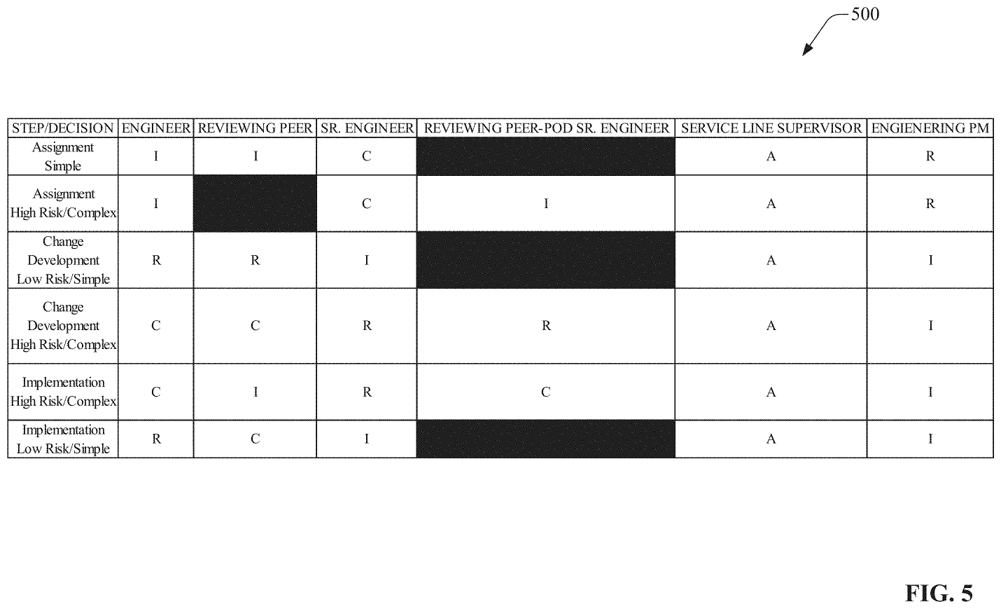

FIG. 5 illustrates an exemplary RACI matrix 500 in accordance with one or more embodiments described herein. According to an embodiment, “R” can represent “Responsible”, “A” can represent “Accountable”, “C” can represent “Consulted”, and “I” can represent “Informed”. It is noted that systems herein (e.g., system 1502) can facilitate assignment of responsibilities according to RACI matrix 500, though it is noted that RACI matrix 500 is exemplary and that other responsibilities can be utilized or assigned in various embodiments described herein. RACI matrix 500 can be generated, for instance, using an ML component 1508 of a system 1502. In this regard, the ML component 1508 determine various risks associated with associated problems or changes, and determine responsibilities based on the problem and/or risks.

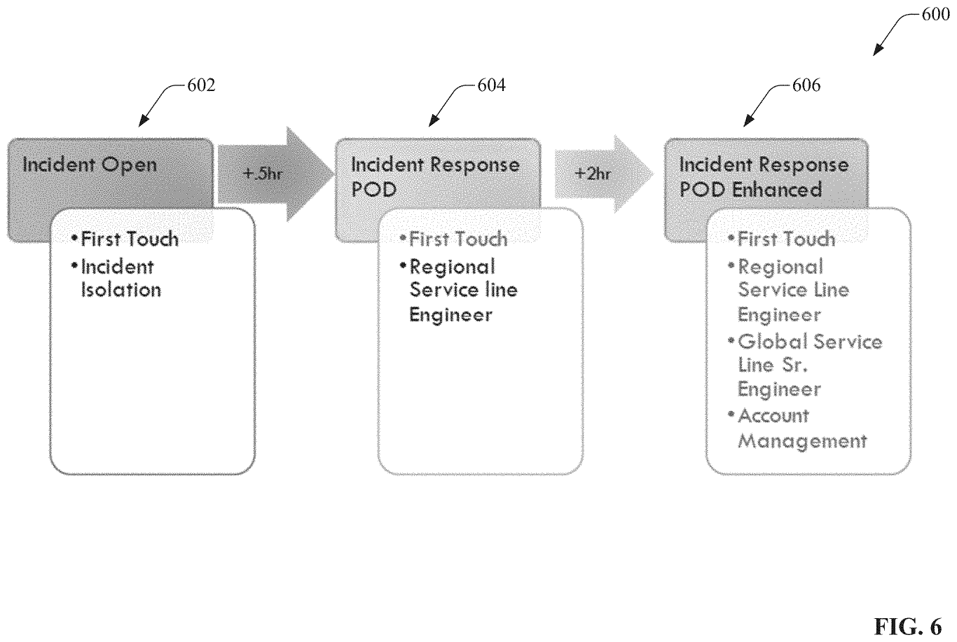

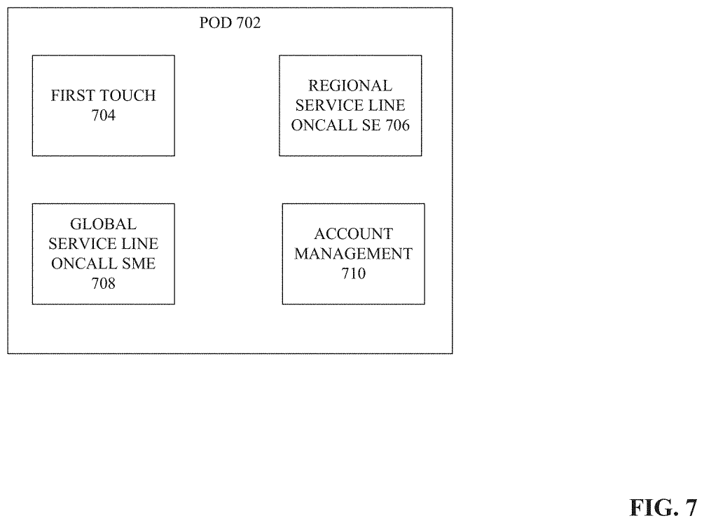

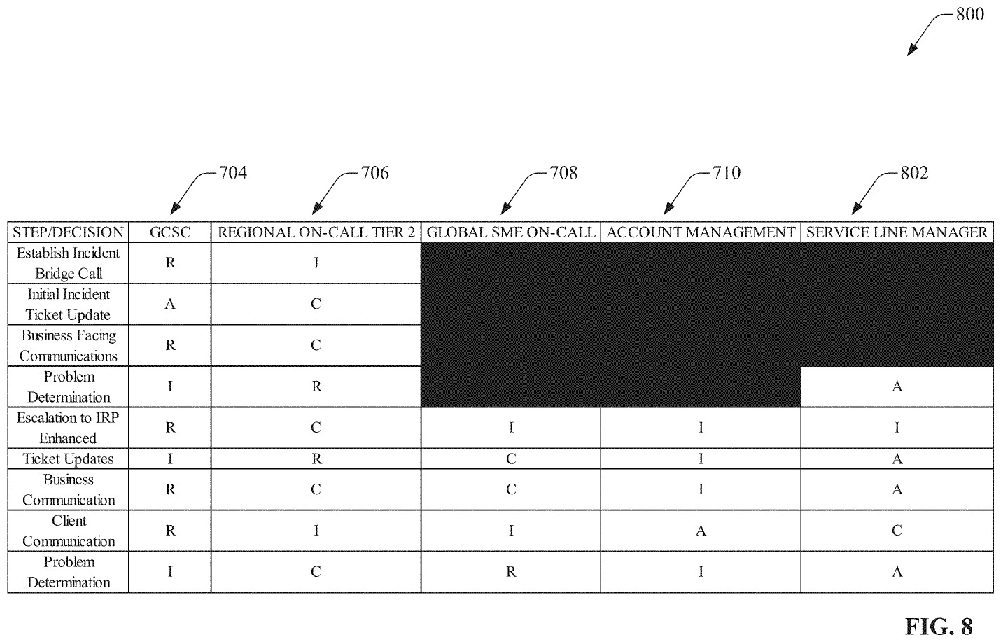

FIG. 6 represents an exemplary process 600 in accordance with one or more embodiments described herein. According to an embodiment, a system herein (e.g., system 1502) can receive information associated with an incident. At 602, systems herein (e.g., system 1502) can open an incident. Opening an incident can comprise incident isolation and/or first touch by a system 1502. In other embodiments, a system herein (e.g., system 1502) can assign a pod (e.g., pod 102 or pod 702) to the incident at 602, and first touch can per facilitated by first touch resource 704 of a pod 702 as depicted in FIG. 7. It is noted that a first touch resource 704 can facilitate initial triage of an incident. According to an embodiment, a first touch resource can comprise a network generalist resource. At 604, a regional service line engineer resource 706 (or a profile associated with a regional service line engineer) can be instructed by an associated system (e.g., system 1502) to perform an action associated with the incident. At 606, systems herein (e.g., system 1502) can assign more resources to the pod 702 and/or incident. For instance, a global subject matter expert resource 708 and/or account management 710 resources can be assigned to the incident (or profiles associated with the foregoing resources). In other embodiments, additional resources can comprise another pod. FIG. 8 illustrates an exemplary RACI matrix 800 in accordance with various embodiments herein. RACI matrix 800 illustrates exemplary responsibilities of the first touch resource 704, regional service line engineer resource 706, global subject matter expert resource 708, account management resource 710, and/or service line manager resource 802. It is noted that the global subject matter expert resource 708 can be selected (e.g., by the system 1502) based on technical mentorship abilities with respect to other members of the pod 702. It is noted that the system 1502 can additionally determine that an engineering resource may have acquired a new skill (e.g., by virtue of pod placement with a subject matter expert resource). In this regard, the system 1502 can assign the new skill to a profile (e.g., engineer profile 1102) associated with the resource, or further evaluate performance of the engineering resource (e.g., future success or failure to solve problems) to determine whether the engineering resource has acquired the skill. According to an embodiment, the pod 702 can additionally comprise the service line manager resource 802. According to another embodiment, the RACI matrix 800 can be generated and provided (e.g., by the system 1502) coinciding with assignment of engineering resources to a pod and/or a pod to a problem. According to yet another embodiment, such a RACI matrix 800 and other RACI matrices can be stored in a data storage 1534 of a system 1502.

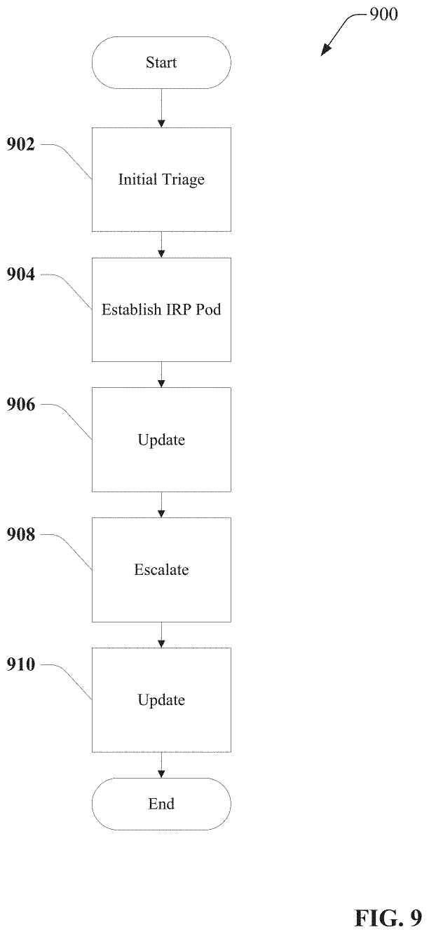

Turning now to FIG. 9, there is illustrates a flowchart of a process 900 for an incident clock in accordance with one or more embodiments described herein. At 902, the process 900 can comprise initial triage of an incident. According to an example, initial triage can be performed by first touch resource 704. Additionally, at 902, a system herein (e.g., system 1502) can begin tracking how long an incident has been open and can map elapsed time to an escalation, communications, or documentation action (e.g., using time component 1530). At 904, in response to receiving an input from the first touch resource 704, a system herein (e.g., system 1502) can establish an incident response pod (IRP) comprising resources associated with the incident (e.g., using profile-pod assignment component 1518). At 906, the system (e.g., system 1502) can receive an update, for instance, from the first touch resource 704. In this regard, the system (e.g., system 1502) can update ticketing information or other information associated with the incident (e.g., according to hourly updates). At 908, after an elapsed duration of a defined amount of time, a system herein (e.g., system 1502) can escalate the incident to another resource (e.g., a global subject matter expert resource 708.) At 910, the system herein (e.g., system 1502) can provide an update to a client associated with the incident (e.g., using communication component 1522). According to an example, the system herein (e.g., system 1502) can provide hourly updates.

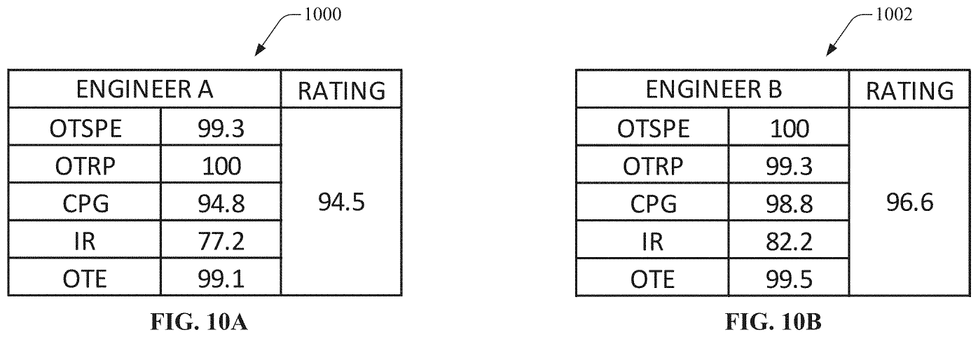

With reference to FIG. 10, there are illustrated exemplary key performance indicator (KPI) charts 1000 and 1002 in accordance with one or more embodiments described herein. In charts 1000 and 1002, OTSPE can represent a Percentage of Other than Successful Changes (e.g., for an engineer resource herein). OTRP can represent a Percentage of Other than Successful Changes (e.g., for a reviewing peer resource herein). CPG can represent Percentage of On Time Change Process Gates. IR can represent Percentage of Incidents resolved prior to Technical escalation. Additionally, OTE can represent Percentage of On Time Escalations. Use of such KPIs can facilitate change development, change execution, and/or incident resolution. Depending on an area of focus, any component of the KPIs can be weighted. According to an example as depicted in FIGS. 10A and 10B, OSTPE can be weighted 2x as a logical lever point. Respective components can be weighted to generate an Engineering Rating (e.g., by a rating component 1520 of a system 1502). Each Engineer Rating can then be utilized by a system herein (e.g., system 1502) as a point of reference in performance review and/or identification of educational opportunities. In other embodiments, an Engineering Rating can be generated, by a system herein (e.g., system 1502), and provided to a management entity for education and/or staffing decision-making. It is noted that KPIs herein can be utilized to compare engineering resources against one another. It is also noted that ratings herein can be based on OTS (other than successful). In this regard, any solution that deviates from being 100% successful can be treated as not successful for the purposes of ratings herein.

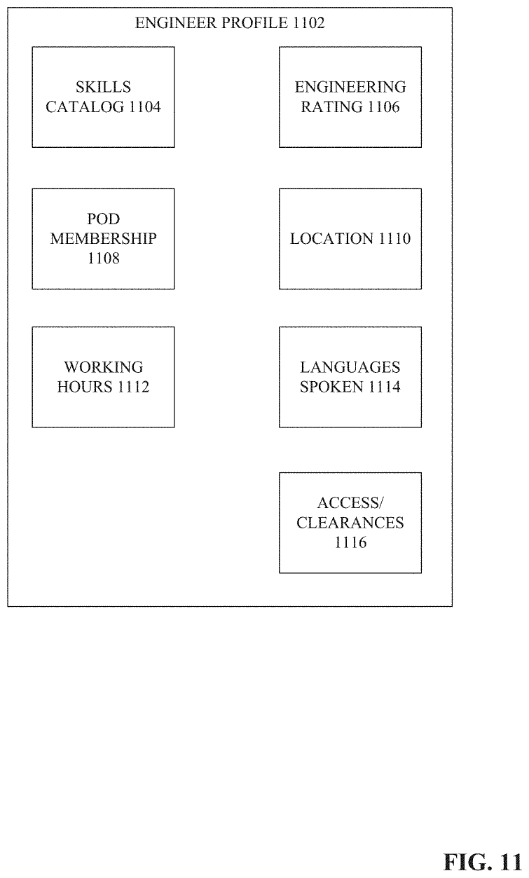

Turning now to FIG. 11, there is illustrated a block diagram of exemplary resource profile information in accordance with one or more embodiments described herein. For instance, an engineer profile 1102 can comprise a skills catalog 1104, engineering rating 1106, pod membership 1108, location 1110, working hours 1112, languages spoken, and/or access/clearances 1116. It is noted that the engineering rating 1106 can be similar to information represented by charts 1000 or 1002. The skills catalog 1104 can comprise skills possessed by a resource associated with the engineering profile 1102. Skills can be defined, for instance, according to survey information and can increase or decreasing by upskilling or downskilling (e.g., in response to performing new tasks and gaining experience or in response to struggling with tasks associated with skills already cataloged in the skills catalog 1104. Such surveys can be performed via self-assessment (e.g., by an engineering resource) or by a system herein (e.g., system 1502) by evaluating such resources (e.g., using machine learning or artificial intelligence as later described in greater detail.) It is noted that such surveys can be utilized (e.g., by system 1502) in order to determine skill data representative of skills of respective engineering profiles (e.g., engineer profile 1102). It is also noted that a system 1502 can determine pod data (e.g., capabilities to solve a defined problem) based on such skill data. Pod membership 1108 can comprise pod(s) membership information for the engineer profile 1102. In this regard pod membership 1108 can represent a pod (e.g., pod 102) that the engineer profile 1102 is associated with or is a member of. It is noted that pod membership 1108 can be based on capabilities of an engineering resource or pod to solve a defined problem. Location 1110 can comprise a geographic location associated with the resource associated with the engineering profile 1102. For instance, location 1110 can comprise a country/nation, state, county/township, city/town, etc. Working hours 1112 can comprise defined working hours associated with the resource associated with the engineering profile 1102. Working hours 1112 can additionally comprise hours permitted to work with/without paid overtime for a resource associated with the engineer profile 1102. Languages spoken 1114 can comprise languages proficiently spoken by the resource associated with the engineering profile 1102. Access/clearances 1116 can comprise security clearances or access to protected information by a resource associated with the engineering profile 1102.

Systems herein (e.g., system 1502) can store such engineering profiles (e.g., engineering profile 1102) which can be indexable and searchable. According to an embodiment, engineering profiles herein can be stored in data store 1534. When a technical request arises, systems herein (e.g., system 1502) can mine data stores (e.g., data store 1534) comprising the engineering profiles in order to best match resources to the technical request. Systems herein (e.g., system 1502) can consider, for instance, potential support restrictions, appropriate skill(s), and/or overtime avoidance measures among other factors. For instance, system 1502 can avoid assignments that would generate additional costs by utilizing resources that would generate overtime costs.

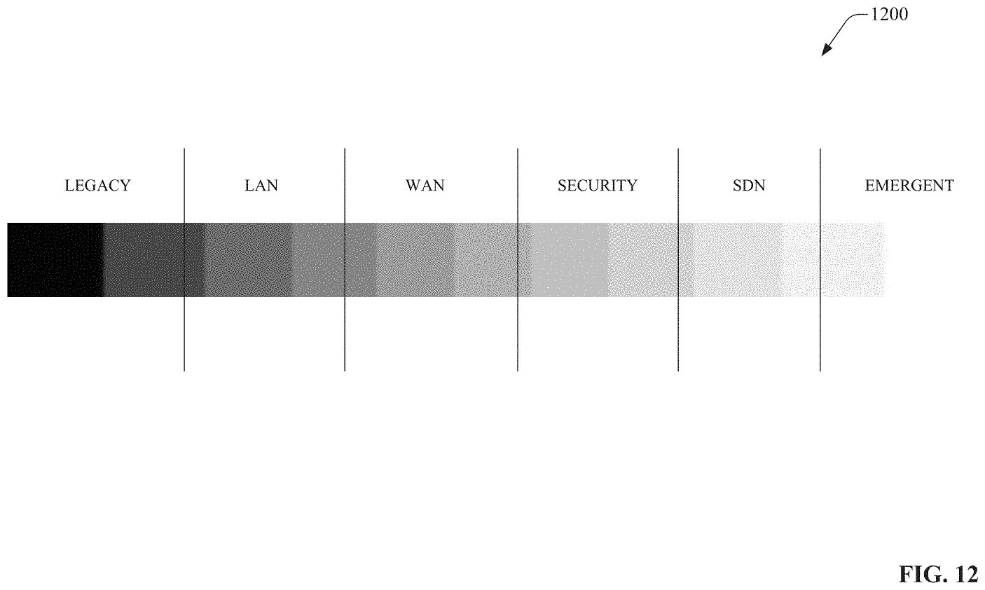

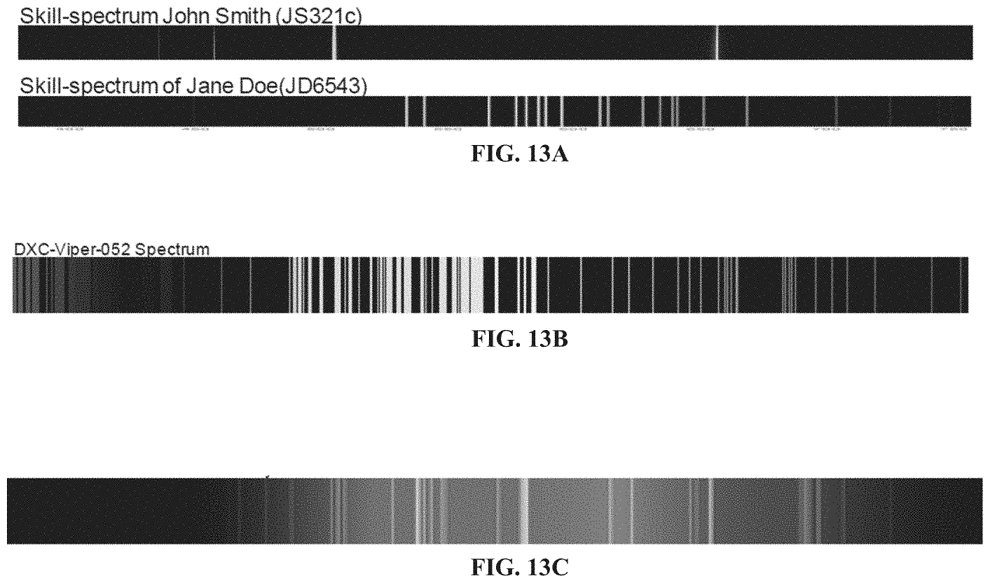

FIG. 12 represents an exemplary spectrum map in accordance with one or more embodiments herein. It is noted that systems herein (e.g., system 1502) can generate spectrum maps, for instance, to provide insight into engineers/resources, pods, and/or global organization(s). According to an embodiment, FIG. 12 represents a spectrum map illustrating exemplary resource allocation sorted by technological maturity. Older technologies can be towards the left, and newer technologies can be represented towards the right. FIGS. 13A-13B illustrate skill spectrums in accordance with one or more embodiments described herein. FIG. 13A represents a skill spectrum of two different engineering resources. By overlaying FIG. 13A overtop FIG. 12, respective skills of respective engineering resources can be made easily visible (e.g., by a system 1502 which can facilitate generation of such skill spectrum maps). FIG. 13B represents a skill spectrum of a pod. By overlaying FIG. 13B overtop FIG. 12, respective skills of a pod can be made easily visible (e.g., by a system 1502 which can facilitate generation of such skill spectrum maps). FIG. 13C can represent a workflow spectrum (e.g., a generated by a system 1502). Workflow spectrums can capture volume of work (e.g., assurance and delivery) that target specific technologies and supported device and can incorporate spectrum mapping as described herein. It is noted that, while depicted in black/white in FIGS. 12-13, spectrum maps can comprise color representations. Such spectrum maps can be generated or otherwise provided, for instance, by a graphical user interface (GUI) 1510 of a system 1502.

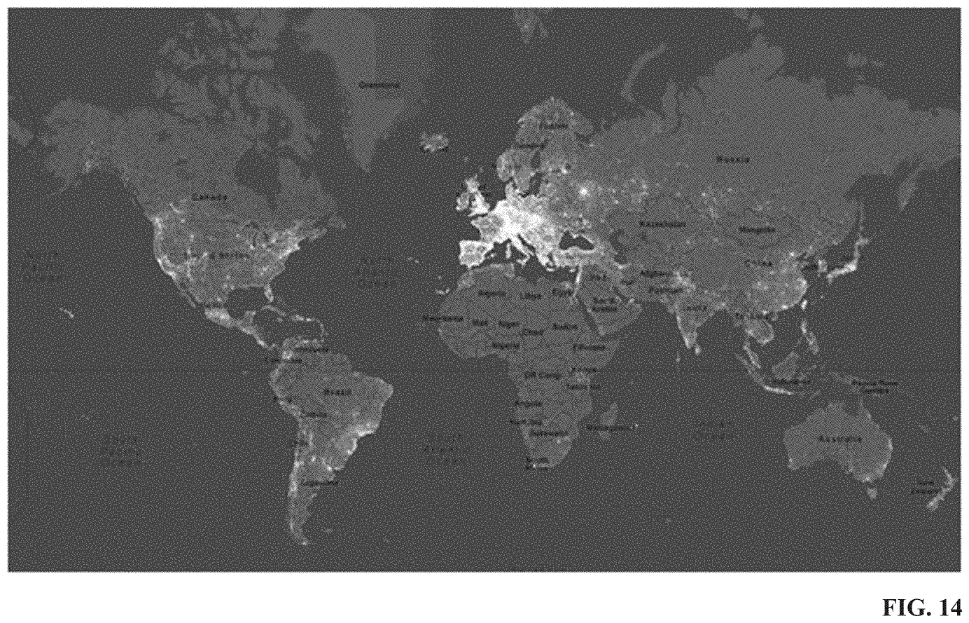

FIG. 14 illustrates an exemplary heatmap in accordance with one or more embodiments described herein. Heatmaps described herein (e.g., as generated by system 1502) can depict global skillset distribution, ticket velocities per skillset, or other information. Such heatmaps can visualize organizational capabilities, workflows, and/or industry trends. It is noted that, while depicted in black/white in FIG. 14, heatmaps herein can comprise color representations. Such heatmaps can be generated or otherwise provided, for instance, by GUI 1510 of system 1502.

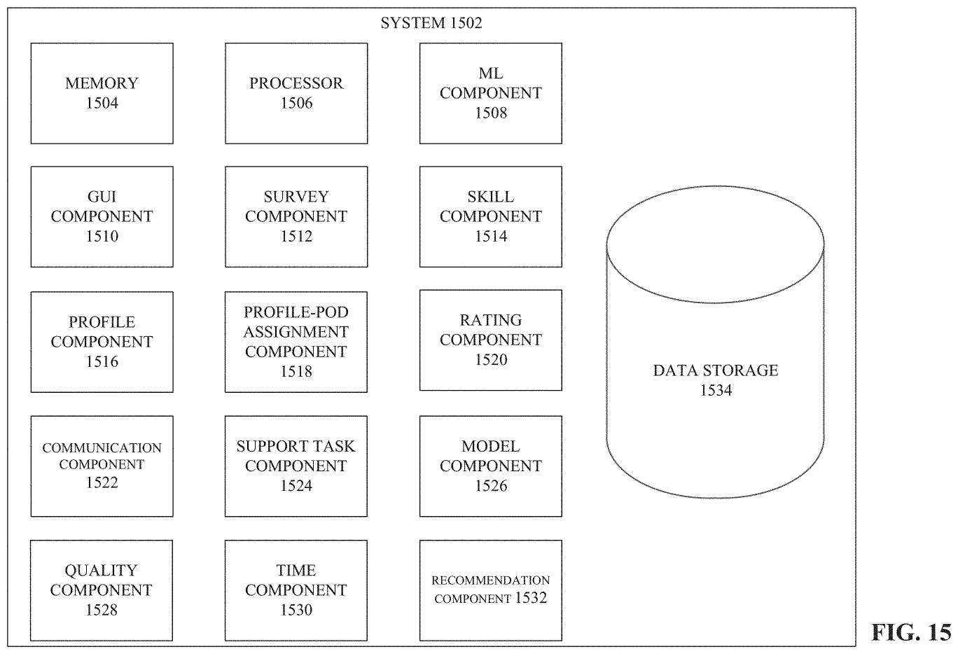

FIG. 15 illustrates an exemplary system 1502 in accordance with various embodiments described herein. System 1502 can be configured to perform various operations relating to scaled engineering operations. The system 1502 can comprise one or more of a variety of components, such as memory 1054, processor 1506, ML component 1508, GUI component 1510, survey component 1512, skill component 1514, profile component 1516, assignment component 1518, rating component 1520, communication component 1522, support task component 1524, model component 1526, quality component 1528, time component 1530, recommendation component 1532, and/or data storage component 1534.

In various embodiments, one or more of the memory 1054, processor 1506, ML component 1508, GUI component 1510, survey component 1512, skill component 1514, profile component 1516, assignment component 1518, rating component 1520, communication component 1522, support task component 1524, model component 1526, quality component 1528, time component 1530, recommendation component 1532, and/or data storage component 1534 can be communicatively or operably coupled (e.g., over a bus or wireless network) to one another to perform one or more functions of the system 1502.

According to an embodiment, the system 1502 can generate a GUI, for instance, using the GUI component 1510. In an embodiment, such a GUI can be provided on a display component (e.g., a screen or a touch screen) communicatively coupled to the system 1502. In various embodiments, the GUI component 1510 generate visualizations (e.g., heatmaps, spectrum maps, workflow spectrums, skill spectrums, RACI matrices, KPIs, or other relevant information.)

It is noted that the communication component 1522 can be utilized to communicatively couple the system 1502, for instance, to a network. In this regard, the system 1502 can communicate with user equipment or other components or systems using the communication component 1522. It is noted that the user equipment can comprise, for instance, a computer, mobile device such as a smartphone, a tablet, laptop, desktop, or other user equipment (e.g., possessing internet access). In various embodiments, the GUI component 1510 can generate a user interface (UI) on a website, desktop or mobile application, etc., as made accessible to user equipment using the communication component 1522.

According to an embodiment, the communication component 1522 can comprise the hardware required to implement a variety of communication protocols (e.g., infrared (“IR”), shortwave transmission, near-field communication (“NFC”), Bluetooth, Wi-Fi, long-term evolution (“LTE”), 3G, 4G, 5G, global system for mobile communications (“GSM”), code-division multiple access (“CDMA”), satellite, visual cues, radio waves, etc.)

In one or more embodiments, the survey component 1512 can be operable, for instance, to populate a data storage 1534 (e.g., a database or data lake) with profile information (e.g., associated with an engineering profile such as an engineering profile 1102) as provided via surveys received by the system 1502 or account information (e.g., account profile 402). It is noted that the data storage 1534 can be organized (e.g., by processor 1506) according to geographical boundaries (e.g., by country). In various embodiments, the data storage 1534 can comprise operational information, skillset data, account profile data, and/or services registered with the system 1502 in addition to other information.

According to an embodiment, the survey component 1512 can generate such surveys comprising questionnaires in order to gather information concerning various resources such as engineering resources. The skill component 1514 can utilize such survey information to determine skill information regarding respective engineering resources. Additionally, the skill component 1514 can receive other information (e.g., performance review information) in order to determine various skill information associated with respective engineering resources. According to an embodiment, the profile component 1516 can generate a profile (e.g., an engineering profile 1102) associated with a respective engineering resource. The profile component 1516 can utilize, for instance, skill information determined by the skill component 1514 and/or survey information received by the survey component 1512. The profile-pod assignment component 1518 can generate pods using, for instance, engineering profiles generated by the profile component 1516 and information associated with an engineering problem or past engineering problem(s) and/or known or predicted solutions (e.g., as assisted by the ML component 1508). In this regard, the profile-pod assignment component 1518 can generate the pod 102, pod 302, pod 702, or other suitable pods. It is noted that the profile-pod assignment component 1518 can leverage ML component 1508 in order to better facilitate auto-assignment of profiles to pods, for instance, by analyzing operational information of the data storage 1534. According to an embodiment, data storage 1534 can be initially populated using survey information and can be continuously updated using information acquired or determined by the system 1502.

According to an embodiment, the rating component 1520 can generate a rating associated with an engineering resource. For instance, the rating can be based on performance information (e.g., KPI or success information) and which can comprise information similar to information contained in charts 1000 and/or 1002. According to an embodiment, one or more weights (e.g., importance weights) for a rating can be utilized by the rating component 1520. Such weights can be predefined or can be determined (e.g., using the ML component 1508) based on evaluation of impacts of ratings on overall business or system performance. According to an embodiment, ratings determined by the rating component 1520 can be utilized by the profile-pod assignment component 1518 in order to determine which engineering resource to assign to a respective pod.

The support task component 1524 can receive a support request (e.g., a support ticket or an engineering/network change request). According to an embodiment, the support task component 1524 can associate the support request with an engineering pod (e.g., pod 102 or 702), for instance, based on required skills determined to be associated with the support request and skills associated with an engineering pod (e.g., pod 102 or 702). It is noted that the members of the pod can comprise skills associated with a defined problem (e.g., as associated with such a support request).

According to an embodiment, the support task component 1524 can provide problem information to a group of resources or a group of pods and provide an opportunity for any pod of the group of pods to attempt to solve the problem. The group of pods can comprise pods determined (e.g., by system 1502) to satisfy various customer restriction requirements, geographical restriction requirements, legal requirements, cross-border requirements, or other suitable requirements.

According to an embodiment, a model component 1526 can generate a model associated with support requests and/or engineering pod matches with said support requests. According to another embodiment, such a model can be generated by the model component 1526, for instance, based on machine learning (e.g., assisted by ML component 1508). In this regard, such machine learning can be applied to past assignment information representative of past assignment(s) of various engineering pods and support requests. It is noted that the quality component 1528 can obtain, determine, aggregate, or store (e.g., in data storage 1534) such past performance information in addition to other tasks or functions. It is also noted that model(s) generated by the model component 1526 can comprise sociotechnical models associated with machine learning and/or auto-assignment functionality. According to an embodiment, a quality level can be associated with an amount of time to solve a support request.

According to an embodiment, the model component 1526 can generate model(s) using various skills (e.g., as determined by skill component 1514), skill spectrums, heatmaps, predictive industry insight (e.g., using ML component 1508), lessons learned (e.g., success or lack of success associated with solutions to problems, changes, pod assignments, peer-pod assignments, resource allocation, or other lessons) rather than traditional root cause analysis (which generally focuses on what went “wrong” rather than also evaluating what went “right” in addition to what went “wrong”). In this regard, the model component 1526 can also analyze what went “right” in addition to what went “wrong”.

According to an embodiment, the time component 1530 can comprise a time tracker that tracks various metrics associated with the system 1502. For instance, the time component 1530 can comprise an incident clock which can track times associated with events with respect to an incident, support request or ticket, or engineering resource/profile 1102.

The recommendation component 1532 can generate a recommendation for a modification (e.g., to a pod, engineering resource, support task-pod assignment, or a different modification). According to an embodiment, the system 1502 can restructure a pod (e.g., using profile-pod assignment component 1518) in response to a determination by the recommendation component 1532 generating a recommendation for pod restructuring. Pod restructuring can be recommended by the recommendation component 1532, for instance, based on quality information determined by the quality component 1528. Further, a pod can be recommended for restructuring in response to an engineering resource profile (e.g., engineer profile 1102) change, for instance, in response to the respective engineering resource acquiring additional training and/or qualification(s).

Various embodiments herein can employ artificial-intelligence or machine learning systems and techniques to facilitate learning user behavior, context-based scenarios, preferences, etc. in order to facilitate taking automated action with high degrees of confidence. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, or ML components herein can comprise artificial intelligence component(s) which can employ an artificial intelligence (AI) model and/or ML or an ML model that can learn to perform the above or below described functions (e.g., via training using historical training data and/or feedback data).

In some embodiments, ML component 1508 can comprise an AI and/or ML model that can be trained (e.g., via supervised and/or unsupervised techniques) to perform the above or below-described functions using historical training data comprising various context conditions that correspond to various management operations. In this example, such an AI and/or ML model can further learn (e.g., via supervised and/or unsupervised techniques) to perform the above or below-described functions using training data comprising feedback data, where such feedback data can be collected and/or stored (e.g., in memory) by an ML component 1508. In this example, such feedback data can comprise the various instructions described above/below that can be input, for instance, to a system herein, over time in response to observed/stored context-based information.

AI/ML components herein can initiate an operation(s) associated with a based on a defined level of confidence determined using information (e.g., feedback data). For example, based on learning to perform such functions described above using feedback data, performance information, and/or past performance information herein, an ML component 1508 herein can initiate an operation associated with generating a pod or associating a pod with a support request. In another example, based on learning to perform such functions described above using feedback data, performance information, and/or past performance information herein, an ML component 1508 herein can initiate an operation associated with generating or updating a model (e.g., to support model component 1526).

In an embodiment, the ML component 1508 can perform a utility-based analysis that factors cost of initiating the above-described operations versus benefit. In this embodiment, an artificial intelligence component can use one or more additional context conditions to determine a pod, pod size, pod assignment, peer-pods, or other relevant information.

To facilitate the above-described functions, the ML component 1508 can perform classifications, correlations, inferences, and/or expressions associated with principles of artificial intelligence. For instance, an ML component 1508 can employ an automatic classification system and/or an automatic classification. In one example, the ML component 1508 can employ a probabilistic and/or statistical-based analysis (e.g., factoring into the analysis utilities and costs) to learn and/or generate inferences. The ML component 1508 can employ any suitable machine-learning based techniques, statistical-based techniques and/or probabilistic-based techniques. For example, the ML component 1508 can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the ML component 1508 can perform a set of machine-learning computations. For instance, the ML component 1508 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

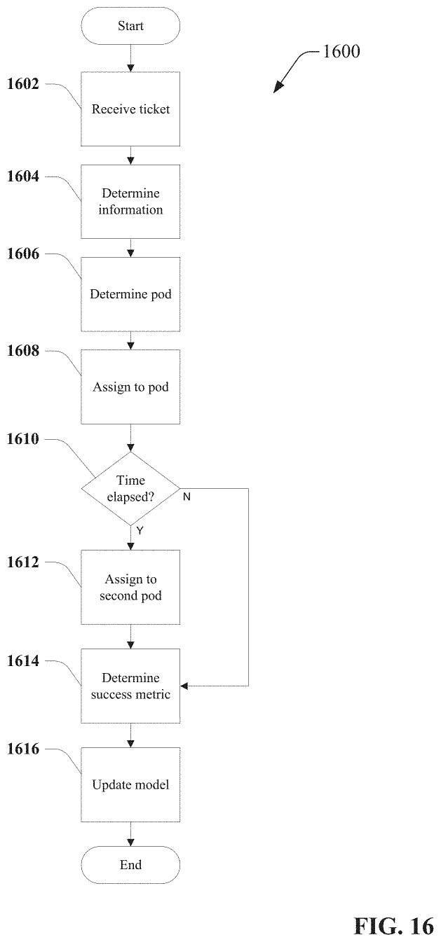

Turning now to FIG. 16, there is illustrated an exemplary flowchart of a process 1600 in accordance with one or more embodiments described herein. At 1602, the process 1600 can comprise receiving (e.g., by a support task component 1524) a ticket (e.g., a support request), corresponding to, for instance, an information technology (IT) problem or a service problem. At 1604, the process can comprise determining information associated with the ticket. According to an example, the information can comprise an identifier associated with solving the IT problem. At 1606, based on the ticket, an engineering pod can be determined from a group of engineering pods (e.g., by a profile-pod assignment component 1518). According to an example, the determined pod can comprise a skill associated with the identifier. At 1608, the determined pod (e.g., a first pod or a primary resolution pod) can be assigned to the ticket to perform a task (e.g., a repair task or a support task) associated with the ticket. At 1610, the time component 1530 can determine whether a defined amount of time has elapsed between assigning the pod to perform the task and a current time (e.g., a second time). According to an embodiment, the time component 1530 can track the amount of time that the ticket is not designated (e.g., by the system 1502) as resolved. At 1610, if the ticket is resolved within the defined amount of time, the process can proceed to 1614. At 1610, if the defined amount of time has elapsed without the ticket being resolved, the process can proceed to 1612. At 1612, a second pod (e.g., a temporary resolution pod) can be assigned to the ticket. The second pod can comprise a temporary support resolution or a dynamic pod, which can comprise a group of subject matter experts associated with the problem and/or that comprise skills associated with the problem. At 1614, one or more success metrics associated with the ticket can be determined. For instance, if a second pod was not required, the success metric can be associated with the first pod and the ticket. If a second pod was required, the success metric can be associated with the first pod's inability to resolve the ticket within the defined amount of time, and/or can be associated with the second pod's ability to resolve the ticket. At 1616, a model associated with the ticket, the IT problem, the pod, and/or the second pod can be updated in order to improve future pod-problem assignments and/or assignment of engineering resources to pods.

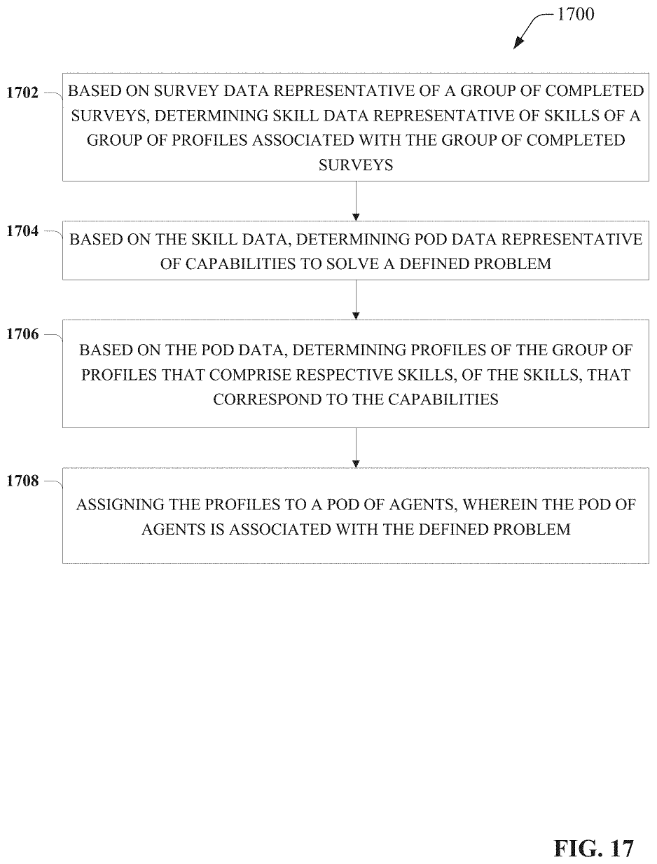

FIG. 17 illustrates a block flow diagram for a process 1700 for assignment of profiles to pods in accordance with one or more embodiments described herein. At 1702, the process 1702 can comprise based on survey data representative of a group of completed surveys, determining skill data representative of skills of a group of profiles associated with the group of completed surveys. At 1704, the process 1700 can comprise based on the skill data, determining pod data representative of capabilities to solve a defined problem. At 1706, the process 1700 can comprise based on the pod data, determining profiles of the group of profiles that comprise respective skills, of the skills, that correspond to the capabilities. At 1708, the process 1700 can comprise assigning the profiles to a pod of agents, wherein the pod of agents is associated with the defined problem.

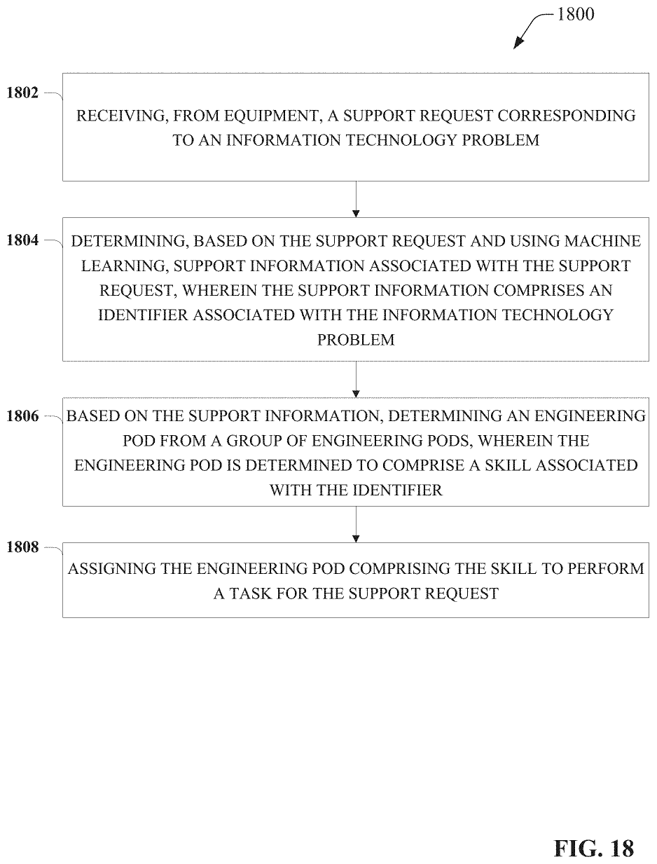

FIG. 18 illustrates a block flow diagram for a process 1800 for assignment an engineering pod to perform a task for a support request in accordance with one or more embodiments described herein. At 1802, the process 1800 can comprise receiving, from equipment, a support request corresponding to an information technology problem. At 1804, the process 1800 can comprise determining, based on the support request and using machine learning, support information associated with the support request, wherein the support information comprises an identifier associated with the information technology problem. At 1806, the process 1800 can comprise based on the support information, determining an engineering pod from a group of engineering pods, wherein the engineering pod is determined to comprise a skill associated with the identifier. At 1808, the process 1800 can comprise assigning the engineering pod comprising the skill to perform a task for the support request.

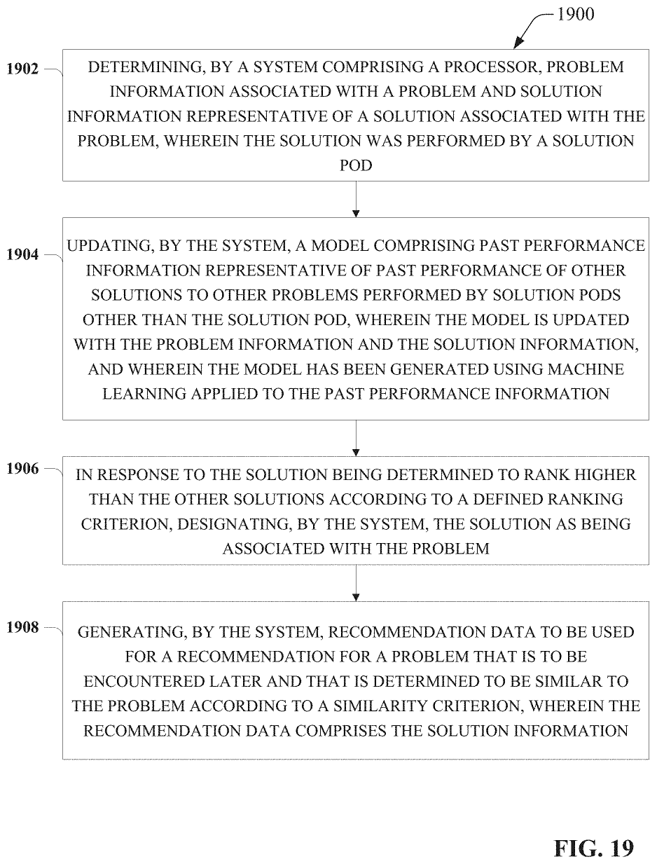

FIG. 19 illustrates a block flow diagram for a process 1900 for generating recommendation data in accordance with one or more embodiments described herein. At 1902, the process 1900 can comprise determining, by a system comprising a processor, problem information associated with a problem and solution information representative of a solution associated with the problem, wherein the solution was performed by a solution pod. At 1904, the process 1900 can comprise updating, by the system, a model comprising past performance information representative of past performance of other solutions to other problems performed by solution pods other than the solution pod, wherein the model is updated with the problem information and the solution information, and wherein the model has been generated using machine learning applied to the past performance information. At 1906, the process 1900 can comprise in response to the solution being determined to rank higher than the other solutions according to a defined ranking criterion, designating, by the system, the solution as being associated with the problem. At 1908, the process 1900 can comprise generating, by the system, recommendation data to be used for a recommendation for a problem that is to be encountered later and that is determined to be similar to the problem according to a similarity criterion, wherein the recommendation data comprises the solution information.

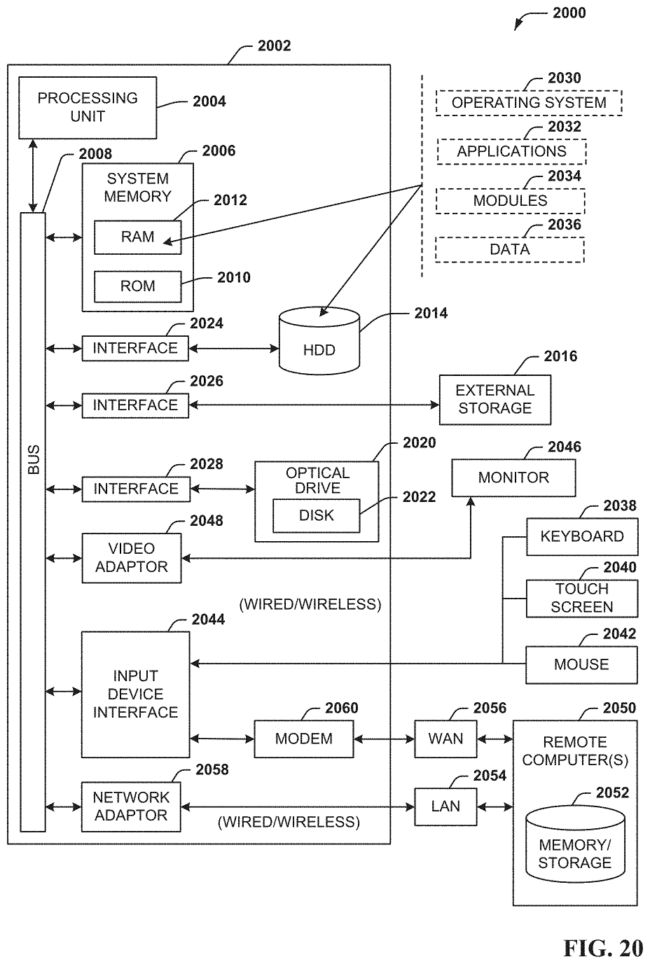

In order to provide additional context for various embodiments described herein, FIG. 20 and the following discussion are intended to provide a brief, general description of a suitable computing environment 2000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 20, the example environment 2000 for implementing various embodiments of the aspects described herein includes a computer 2002, the computer 2002 including a processing unit 2004, a system memory 2006 and a system bus 2008. The system bus 2008 couples system components including, but not limited to, the system memory 2006 to the processing unit 2004. The processing unit 2004 can be any of various commercially available processors. Dual microprocessors and other multi-processor architectures can also be employed as the processing unit 2004.

The system bus 2008 can be any of several types of bus structure that can further interconnect to a memory bus (with or without a memory controller), a peripheral bus, and a local bus using any of a variety of commercially available bus architectures. The system memory 2006 includes ROM 2010 and RAM 2012. A basic input/output system (BIOS) can be stored in a non-volatile memory such as ROM, erasable programmable read only memory (EPROM), EEPROM, which BIOS contains the basic routines that help to transfer information between elements within the computer 2002, such as during startup. The RAM 2012 can also include a high-speed RAM such as static RAM for caching data.

The computer 2002 further includes an internal hard disk drive (HDD) 2014 (e.g., EIDE, SATA), one or more external storage devices 2016 (e.g., a magnetic floppy disk drive (FDD) 2016, a memory stick or flash drive reader, a memory card reader, etc.) and an optical disk drive 2020 (e.g., which can read or write from a CD-ROM disc, a DVD, a BD, etc.). While the internal HDD 2014 is illustrated as located within the computer 2002, the internal HDD 2014 can also be configured for external use in a suitable chassis (not shown). Additionally, while not shown in environment 2000, a solid-state drive (SSD) could be used in addition to, or in place of, an HDD 2014. The HDD 2014, external storage device(s) 2016 and optical disk drive 2020 can be connected to the system bus 2008 by an HDD interface 2024, an external storage interface 2026 and an optical drive interface 2028, respectively. The interface 2024 for external drive implementations can include at least one or both of Universal Serial Bus (USB) and Institute of Electrical and Electronics Engineers (IEEE) 1694 interface technologies. Other external drive connection technologies are within contemplation of the embodiments described herein.

The drives and their associated computer-readable storage media provide nonvolatile storage of data, data structures, computer-executable instructions, and so forth. For the computer 2002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2012, including an operating system 2030, one or more application programs 2032, other program modules 2034 and program data 2036. All or portions of the operating system, applications, modules, and/or data can also be cached in the RAM 2012. The systems and methods described herein can be implemented utilizing various commercially available operating systems or combinations of operating systems.

Computer 2002 can optionally comprise emulation technologies. For example, a hypervisor (not shown) or other intermediary can emulate a hardware environment for operating system 2030, and the emulated hardware can optionally be different from the hardware illustrated in FIG. 20. In such an embodiment, operating system 2030 can comprise one virtual machine (VM) of multiple VMs hosted at computer 2002. Furthermore, operating system 2030 can provide runtime environments, such as the Java runtime environment or the .NET framework, for applications 2032. Runtime environments are consistent execution environments that allow applications 2032 to run on any operating system that includes the runtime environment. Similarly, operating system 2030 can support containers, and applications 2032 can be in the form of containers, which are lightweight, standalone, executable packages of software that include, e.g., code, runtime, system tools, system libraries and settings for an application.

Further, computer 2002 can be enable with a security module, such as a trusted processing module (TPM). For instance, with a TPM, boot components hash next in time boot components, and wait for a match of results to secured values, before loading a next boot component. This process can take place at any layer in the code execution stack of computer 2002, e.g., applied at the application execution level or at the operating system (OS) kernel level, thereby enabling security at any level of code execution.

A user can enter commands and information into the computer 2002 through one or more wired/wireless input devices, e.g., a keyboard 2038, a touch screen 2040, and a pointing device, such as a mouse 2042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2004 through an input device interface 2044 that can be coupled to the system bus 2008, but can be connected by other interfaces, such as a parallel port, an IEEE 1394 serial port, a game port, a USB port, an IR interface, a BLUETOOTH® interface, etc.

A monitor 2046 or other type of display device can be also connected to the system bus 2008 via an interface, such as a video adapter 2048. In addition to the monitor 2046, a computer typically includes other peripheral output devices (not shown), such as speakers, printers, etc.

The computer 2002 can operate in a networked environment using logical connections via wired and/or wireless communications to one or more remote computers, such as a remote computer(s) 2050. The remote computer(s) 2050 can be a workstation, a server computer, a router, a personal computer, portable computer, microprocessor-based entertainment appliance, a peer device or other common network node, and typically includes many or all of the elements described relative to the computer 2002, although, for purposes of brevity, only a memory/storage device 2052 is illustrated. The logical connections depicted include wired/wireless connectivity to a local area network (LAN) 2054 and/or larger networks, e.g., a wide area network (WAN) 2056. Such LAN and WAN networking environments are commonplace in offices and companies, and facilitate enterprise-wide computer networks, such as intranets, all of which can connect to a global communications network, e.g., the Internet.

When used in a LAN networking environment, the computer 2002 can be connected to the local network 2054 through a wired and/or wireless communication network interface or adapter 2058. The adapter 2058 can facilitate wired or wireless communication to the LAN 2054, which can also include a wireless access point (AP) disposed thereon for communicating with the adapter 2058 in a wireless mode.

When used in a WAN networking environment, the computer 2002 can include a modem 2060 or can be connected to a communications server on the WAN 2056 via other means for establishing communications over the WAN 2056, such as by way of the Internet. The modem 2060, which can be internal or external and a wired or wireless device, can be connected to the system bus 2008 via the input device interface 2044. In a networked environment, program modules depicted relative to the computer 2002 or portions thereof, can be stored in the remote memory/storage device 2052. It will be appreciated that the network connections shown are example and other means of establishing a communications link between the computers can be used.

When used in either a LAN or WAN networking environment, the computer 2002 can access cloud storage systems or other network-based storage systems in addition to, or in place of, external storage devices 2016 as described above. Generally, a connection between the computer 2002 and a cloud storage system can be established over a LAN 2054 or WAN 2056 e.g., by the adapter 2058 or modem 2060, respectively. Upon connecting the computer 2002 to an associated cloud storage system, the external storage interface 2026 can, with the aid of the adapter 2058 and/or modem 2060, manage storage provided by the cloud storage system as it would other types of external storage. For instance, the external storage interface 2026 can be configured to provide access to cloud storage sources as if those sources were physically connected to the computer 2002.

The computer 2002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

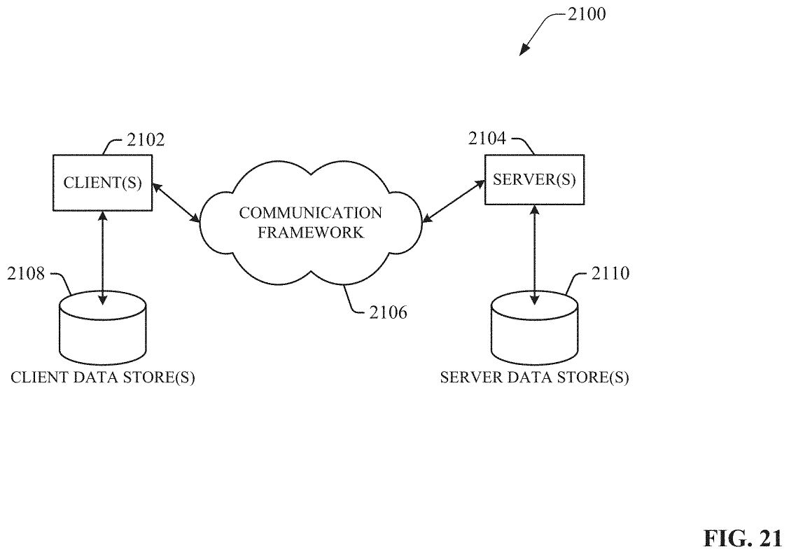

Referring now to FIG. 21, there is illustrated a schematic block diagram of a computing environment 2100 in accordance with this specification. The system 2100 includes one or more client(s) 2102, (e.g., computers, smart phones, tablets, cameras, PDA's). The client(s) 2102 can be hardware and/or software (e.g., threads, processes, computing devices). The client(s) 2102 can house cookie(s) and/or associated contextual information by employing the specification, for example.

The system 2100 also includes one or more server(s) 2104. The server(s) 2104 can also be hardware or hardware in combination with software (e.g., threads, processes, computing devices). The servers 2104 can house threads to perform transformations of media items by employing aspects of this disclosure, for example. One possible communication between a client 2102 and a server 2104 can be in the form of a data packet adapted to be transmitted between two or more computer processes wherein data packets may include coded analyzed headspaces and/or input. The data packet can include a cookie and/or associated contextual information, for example. The system 2100 includes a communication framework 2106 (e.g., a global communication network such as the Internet) that can be employed to facilitate communications between the client(s) 2102 and the server(s) 2104.

Communications can be facilitated via a wired (including optical fiber) and/or wireless technology. The client(s) 2102 are operatively connected to one or more client data store(s) 2108 that can be employed to store information local to the client(s) 2102 (e.g., cookie(s) and/or associated contextual information). Similarly, the server(s) 2104 are operatively connected to one or more server data store(s) 2110 that can be employed to store information local to the servers 2104.

In one exemplary implementation, a client 2102 can transfer an encoded file, (e.g., encoded media item), to server 2104. Server 2104 can store the file, decode the file, or transmit the file to another client 2102. It is noted that a client 2102 can also transfer uncompressed file to a server 2104 and server 2104 can compress the file and/or transform the file in accordance with this disclosure. Likewise, server 2104 can encode information and transmit the information via communication framework 2106 to one or more clients 2102.

The illustrated aspects of the disclosure may also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a processor; and
a memory that stores executable instructions that, when executed by the processor, facilitate performance of operations, comprising:
based on survey data representative of a group of completed surveys, determining skill data representative of skills of a group of profiles associated with the group of completed surveys;
based on the skill data, determining pod data representative of capabilities to solve a defined problem;
based on the pod data, determining profiles of the group of profiles that comprise respective skills, of the skills, that correspond to the capabilities; and
assigning the profiles to a pod of agents, wherein the pod of agents is associated with the defined problem.

2. The system of claim 1, wherein determining the skill data comprises determining the skills using respective ratings assigned to the group of profiles.

3. The system of claim 1, wherein the operations further comprise:
receiving a ticket indicative of a support task;
determining information associated with the support task;
based on the information associated with the support task, determining whether the support task corresponds to the defined problem; and
in response to determining that the support task corresponds to the defined problem, assigning the pod of agents to the support task.

4. The system of claim 3, wherein the information associated with the support task comprises an engineering risk grade comprising a risk value associated with a risk of implementing a change associated with the support task.

5. The system of claim 3, wherein determining the pod of agents is based on a model generated using machine learning based on past assignments of pods of agents to support tasks.

6. The system of claim 3, wherein the operations further comprise:
determining a quality level associated with the assigning of the pod of agents to the support task in response to the support task being determined to be completed.

7. The system of claim 6, wherein the quality level is indicative of an amount of time to solve the support task.

8. The system of claim 1, wherein assigning the profiles to the pod of agents is based on a model generated using machine learning based on past assignments of profiles to pods of agents.

9. The system of claim 1, wherein the pod of agents consists of five agents.

10. The system of claim 1, wherein the profiles comprise at least one subject matter expert profile, and wherein the subject matter expert profile is determined, according to a defined criterion, to comprise a skill level above a subject matter expert skill level threshold for the defined problem.

11. A non-transitory machine-readable medium, comprising executable instructions that, when executed by a processor, facilitate performance of operations, comprising:
receiving, from equipment, a support request corresponding to an information technology problem;
determining, based on the support request and using machine learning, support information associated with the support request, wherein the support information comprises an identifier associated with the information technology problem;
based on the support information, determining an engineering pod from a group of engineering pods, wherein the engineering pod is determined to comprise a skill associated with the identifier; and
assigning the engineering pod comprising the skill to perform a task for the support request.

12. The non-transitory machine-readable medium of claim 11, wherein assigning the engineering pod comprising the skill to perform a task for the support request comprises assigning a first engineering pod comprising the skill to perform a first task for the support request, and wherein the operations further comprise:
in response to a defined amount of time elapsing between a first time comprising assigning the first engineering pod to perform the first task and a second time occurring after the first time, assigning a second engineering pod to perform a second task for the support request.

13. The non-transitory machine-readable medium of claim 12, wherein the second task is different than the first task, wherein the engineering pod is a primary resolution pod, and wherein the second engineering pod is a temporary resolution pod.

14. The non-transitory machine-readable medium of claim 13, wherein the temporary resolution pod is generated, using the machine learning, based on the identifier and the primary resolution pod, and wherein the temporary resolution pod comprises a subject matter expert profile determined to be associated with the identifier.

15. The non-transitory machine-readable medium of claim 14, wherein the operations further comprise:
determining a first success metric associated with the primary resolution pod and a second success metric associated with the temporary resolution pod; and
updating a model of pods comprising the primary resolution pod and the temporary resolution pod with the first success metric and the second success metric, wherein the model of pods has been generated based on the machine learning as applied to past performance information representative of past performances of engineering pods.

16. The non-transitory machine-readable medium of claim 11, wherein a first pod member of the engineering pod comprises the skill and a second member of the engineering pod does not comprise the skill, and wherein the operations further comprise:
associating the skill with the second member in response to satisfaction of a defined upskill criterion by the engineering pod.

17. The non-transitory machine-readable medium of claim 16, wherein the defined upskill criterion comprises a total threshold time performed by the engineering pod on information technology problems determined to be similar to the information technology problem according to a similarity criterion.

18. The non-transitory machine-readable medium of claim 11, wherein the operations further comprise:
determining a group of profiles other than profiles of the engineering pod, wherein each profile of the group of profiles comprises the skill and is a respective member of a pod other than the engineering pod; and
assigning the group of profiles to the support request.

19. A method, comprising:
determining, by a system comprising a processor, problem information associated with a problem and solution information representative of a solution associated with the problem, wherein the solution was performed by a solution pod;
updating, by the system, a model comprising past performance information representative of past performance of other solutions to other problems performed by solution pods other than the solution pod, wherein the model is updated with the problem information and the solution information, and wherein the model has been generated using machine learning applied to the past performance information;
in response to the solution being determined to rank higher than the other solutions according to a defined ranking criterion, designating, by the system, the solution as being associated with the problem; and
generating, by the system, recommendation data to be used for a recommendation for a problem that is to be encountered later and that is determined to be similar to the problem according to a similarity criterion, wherein the recommendation data comprises the solution information.

20. The method of claim 19, wherein the solution pod comprises at least two engineering profiles and a subject matter expert profile.
